(19) United States
(12) Patent Application Publication
(10) Pub. No.: US 2006/0255501 A1
(43) Pub. Date: Nov. 16, 2006

(54) Crosslinked chlorinated polyolefin compositions

(75) Inventors: Peter Jackson, Toronto (CA); Joseph R. Prema, Richmond Hill (CA)

Correspondence Address: KIRKPATRICK & LOCKHART NICHOLSON GRAHAM LLP, 535 SMITHFIELD STREET, PITTSBURGH, PA, 15222, US

(73) Assignee: ShawCor Ltd.

(21) Appl. No.: 11/126,540

(22) Filed: May 11, 2005

(51) Int. Cl. B29B 7/00; B29C 71/00; C08F 8/00

(52) U.S. Cl. 264/236; 264/349; 525/192

(57) ABSTRACT

A chlorinated polyolefin composition suitable for use in the manufacture of crosslinked, thermoset, flame-retardant articles such as jackets for electrical or fiber optic cables and heat-shrinkable tubing for protection of cable connectors and splices. The composition is thermosetting and moisture curable and comprises a chlorinated polyolefin such as chlorinated polyethylene or chlorosulfonated polyethylene and a non-chlorinated polyolefin which contains moisture crosslinkable silane groups. The non-chlorinated polyolefin preferably comprises polyethylene or a copolymer thereof. Exposure of the composition to moisture causes the formation of intermolecular crosslinks between molecules of the non-chlorinated polyolefin. The compositions can be formed by blending the non-chlorinated polyolefin with a silanated non-chlorinated polyolefin or by silane-grafting a blend of the chlorinated polyolefin and the non-chlorinated polyolefin.

### FIELD OF THE INVENTION

This invention relates to crosslinked, flame-retardant polymer compositions and articles made therefrom. In particular, the invention relates to chlorinated polyolefin-based compositions for use in the manufacture of crosslinked, thermoset articles such as jackets for electrical cables or fibre optic cables, and heat-shrinkable tubing for protection of cable connectors and splices.

### BACKGROUND OF THE INVENTION

In the manufacture of electrical cable, flame-retardant polymers are used to form an insulating layer over the individual electrical conductors and to form an outer protective jacket surrounding all the conductors. Flame retardancy is typically a major performance requirement for jacketing materials used in wire and cable applications. Cables are generally required to meet standardized industrial specifications of flame-retardancy and to provide a resistance to flame propagation and protect critical electrical circuits in the case of a fire.

Some of the more commonly used flame-retardant polymers are chlorinated polymers such as polychloroprene, chlorosulfonated polyethylene, polyvinylchloride and chlorinated polyethylene. A big advantage of chlorinated polymers for wire and cable applications is that they are, to a large extent, inherently flame-retardant due to the presence of chlorine in the polymer. This property can also be further enhanced by the addition of flame-retardant additives. Another advantage of chlorinated polymers is their good resistance to oils and chemicals versus non-chlorinated polymers.

The outer protective jacket of an electrical cable, such as that used in equipment power and instrument control applications, is in contact with the surrounding environment, and can be subjected to harsh conditions. In many cases it is necessary to crosslink the jacket material to meet the demands of industry for these products. Crosslinking renders the material thermoset and imparts much improved performance over uncrosslinked thermoplastic materials in the areas of heat resistance, flame-retardancy, service temperature rating, hot deformation resistance, oil and solvent resistance, toughness, tensile strength, abrasion resistance and cut-through resistance.

It is known that chlorinated polyolefin-based polymers can be crosslinked by electron beam radiation. However, such radiation crosslinking requires complex equipment and is therefore relatively costly to perform. Furthermore, radiation can cause chlorinated polymers to be degraded by oxidation, dehydrochlorination and chain scission, requiring that they be specially stabilized to prevent this. In addition, costly radiation sensitizers are generally needed to achieve usable levels of crosslinking at doses below the level at which degradation becomes predominant. Furthermore, the sizes of cable which can be handled by commercial radiation equipment are limited, both in terms of jacket thickness and overall diameter of the cable. This limitation is typically manifested as non-uniform crosslinking of the jacket and a resultant variation in physical properties around the circumference of the cable or within the material wall of the jacket. To compensate for this, large diameter cables or cables with thick jackets are usually “over-irradiated” to ensure at least the minimum required dosage is achieved at all points of the jacket.

It is also well known in the art that chlorinated polyolefin polymers may be crosslinked by chemical methods such as peroxide and, in the case of chlorosulfonated polyethylene, metal oxides and sulfur. However these methods require substantial amounts of heat to effect crosslinking coupled with expensive processing equipment, such as pressurized steam or hot gas caternary lines as used for wire and cable crosslinking. The major disadvantages of using such high temperatures (typically 200 to 350° C.) is potential softening, damage, and oxidative degradation of the polymer.

Moisture crosslinking (also referred to herein as “moisture curing”) is not subject to these disadvantages. It is also a relatively simple and inexpensive process compared with radiation or traditional chemical crosslinking. Moisture curable compositions contain an organic silane which is grafted to or copolymerized with one or more polymers of the composition. Once the composition is formed into an article, the silane molecules form crosslinks between the polymer chains upon exposure to moisture. In the case of chlorinated polyolefins, attachment of the silane is difficult due to so-called “steric hindrance” of the relatively bulky chlorine atoms preventing access of the silane molecules to the main polymer chain.

There remains a need for improved moisture crosslinkable, thermosetting polymer compositions containing flame-retardant chlorinated polyolefins for use in the manufacture of crosslinked, thermoset articles such as cable jackets and heat shrinkable tubing for protection of cable connections and splices.

### SUMMARY OF THE INVENTION

The present invention overcomes the problems of the prior art mentioned above by providing moisture crosslinked, chlorinated polymer compositions and articles made therefrom. The compositions according to the invention are comprised of a chlorinated polyolefin and a non-chlorinated polyolefin which contains moisture crosslinkable silane groups. The inclusion of the silanated, non-chlorinated polyolefin in the composition overcomes difficulties encountered with direct moisture crosslinking of chlorinated polyolefins. Accordingly, the present invention results in the formation of thermoplastic, moisture crosslinked articles which may possess improved properties over those obtained by the prior art processes.

In one aspect, the present invention provides a moisture-crosslinked, flame-retardant article formed from a thermosetting, moisture-crosslinkable polymer composition, the polymer composition comprising a blend of: (a) a chlorinated polyolefin; (b) a non-chlorinated polyethylene selected from the group consisting of polyethylene homopolymers and copolymers; (c) hydrolysable silane groups bonded to molecules of the non-chlorinated polyethylene; and (d) a silanol condensation catalyst; wherein the weight ratio of the chlorinated polyolefin to the non-chlorinated polyethylene is at least about 1:1; wherein the hydrolysable silane groups form silane crosslinks between the polyethylene molecules upon exposure to moisture, and wherein the degree of crosslinking is sufficient to provide the article with thermoset properties.

In another aspect, the present invention provides a method for manufacturing a moisture-crosslinked, flame-retardant article. The method comprises: (a) providing a non-chlorinated, ethylene-based polymer containing hydrolysable silane groups, wherein the ethylene-based polymer comprises ethylene copolymerized with an organic silane, polyethylene homopolymer grafted with an organic silane, or a polyethylene copolymer grafted with an organic silane; (b) blending the ethylene-based polymer with a chlorinated polyolefin and a silanol condensation catalyst to form a moisture-crosslinkable, thermosetting composition, wherein the weight ratio of the chlorinated polyolefin to the ethylene-based polymer is at least about 1:1; (c) melt processing the composition to form the article; (d) exposing the article to moisture so as to hydrolyse at least some of the silane groups of the ethylene-based polymer and thereby form silane crosslinks between molecules of the ethylene-based polymer, wherein the degree of crosslinking is sufficient to impart thermoset properties to the article.

In yet another aspect, the present invention provides a method for manufacturing a moisture-crosslinked, flame-retardant article. The method comprises: (a) blending together a chlorinated polyolefin, a non-chlorinated polyethylene selected from the group consisting of polyethylene homopolymers and copolymers, and an organic silane; (b) forming a grafted polymer mixture by reacting the organic silane with the non-chlorinated polyethylene, thereby grafting the organic silane to the non-chlorinated polyethylene in the form of hydrolysable silane groups; (c) forming a moisture-crosslinkable, thermosetting composition by blending the grafted polymer mixture with a silanol condensation catalyst; (d) melt processing the composition to form the article; (e) exposing the article to moisture so as to hydrolyse at least some of the silane groups and thereby form silane crosslinks between molecules of the non-chlorinated polyethylene, wherein the degree of crosslinking is sufficient to impart thermoset properties to the article.

### DETAILED DESCRIPTION OF PREFERRED EMBODIMENTS

The present invention provides novel flame-retardant polymer compositions and articles made therefrom. The compositions according to the invention are thermosetting, moisture crosslinkable compositions comprising the following:
a chlorinated polyolefin;
a non-chlorinated polyolefin homopolymer or copolymer;
an organic silane grafted to or copolymerized with the non-chlorinated polyolefin.

When formed into an article and exposed to moisture, the silane forms crosslinks between the polymer chains, thereby providing the article with thermoset properties. As used herein, the term “thermoset” with reference to articles and materials according to the invention means that these articles and materials do not become liquid when heated to a temperature above the crystalline melting point of the highest melting polymer component thereof. The thermoset properties of the articles and materials according to the invention are a result of the silane crosslinking which prevents the molecules from separating when heated.

The inventors have found that articles produced according to the present invention have properties comparable to articles made of radiation crosslinked flame-retardant polymers, while avoiding problems associated with radiation crosslinking.

The compositions according to the invention are preferably comprised predominantly of the chlorinated polyolefin component, which is preferably selected from the group comprising polychloroprene, chlorosulfonated polyethylene, polyvinyl chloride and chlorinated polyethylene. Preferred chlorinated polyolefins are chlorinated polyethylene and chlorosulfonated polyethylene, with chlorinated polyethylene being particularly preferred.

The use of the term “predominantly” herein with reference to the compositions of the invention is intended to mean that the weight of chlorinated polyolefin component present in the composition is approximately the same or greater than the individual weights of the other components of the composition, including the non-chlorinated polyolefin. Preferably, the weight ratio of the chlorinated polyolefin:non-chlorinated polyolefin is at least about 1.5:1, and is more preferably at least about 3:1. In terms of weight percent, the chlorinated polyolefin is preferably present in an amount of at least 20 percent, more preferably at least 35 percent by weight of the total composition. In some preferred embodiments of the invention, the chlorinated polyolefin is preferably present in an amount ranging from about 25 to 75 percent by weight, more preferably from about 35 to 65 percent by weight.

The chlorinated polyolefin component of the composition is prepared commercially by the chlorination of polyethylene. Preferred chlorinated polyethylenes have a chlorine content of between about 25% and 45% by weight and density in the range from about 1.15 g/cm³ to about 1.25 g/cm³. Chlorosulfonated polyethylenes have an additional preferred sulfur content of between about 0.8% and 1.5% by weight, and density in the range from about 1.10 g/cm³to about 1.30 g/cm³.

The non-chlorinated polyolefin component of the composition is preferably a polyethylene homopolymer or copolymer, or a mixture thereof. Suitable non-chlorinated polyethylenes for use in the compositions of the invention are selected from the group comprising polyethylene homopolymers and copolymers of ethylene with an olefin other than ethylene having from 3 to 20 carbon atoms.

Preferred polyethylene homopolymers are selected from the group comprising low density polyethylene, high density polyethylene and linear low density polyethylene, with high-density polyethylene and linear low-density polyethylene being most preferred.

Preferred copolymers of ethylene are selected from those in which the olefin other than ethylene is selected from the group comprising propylene, butene, hexene, octene, ethylidene norbornene, vinyl acetate, methyl acrylate, ethyl acrylate and butyl acrylate. The copolymer of ethylene may also comprise an ethylene-propylene or ethylene-propylene-diene elastomer. The copolymers of ethylene may be prepared using so-called metallocene catalysts.

The non-chlorinated polyethylene preferably comprises from about 50 to about 100% by weight ethylene, more preferably from about 60 to about 90% by weight ethylene, and most preferably from about 80 to about 95% by weight ethylene. The density of the polyethylene or the ethylene co-polymer is preferably in the range of about 0.85 to about 0.95 g/cm³.

The amount of the non-chlorinated polyethylene contained in the composition preferably ranges from about 5% by weight to about 50% by weight, and more preferably from about 10% to about 30% by weight. It will be appreciated that higher levels of crosslinking can be achieved by adding greater amounts of non-chlorinated polyethylene to the composition.

The organic silane crosslinking groups contained in the compositions according to the invention are derived from silanes having the general formula RR′SiY₂ which are reacted with the non-chlorinated polyolefin as discussed below. The group R represents a monovalent olefinically unsaturated hydrocarbon or hydrocarbonoxy radical, Y represents a hydrolysable organic radical and R′ represents a monovalent olefinically unsaturated hydrocarbon, a hydrocarbonoxy radical, or a hydrolysable organic radical.

The monovalent olefinically unsaturated hydrocarbon or hydrocarbonoxy radical is preferably selected from the group comprising vinyl, allyl, butenyl, cyclohexenyl, cyclopentadienyl, or cyclohexadienyl radicals.

The hydrolysable organic radical is preferably selected from the group comprising: alkoxy radicals such as methoxy, ethoxy and butoxy radicals; acyloxy radicals such as formyloxy, acetoxy and propionoxy radicals; oximo radicals such as —ON═C(CH₃)₂, —ON═CCH₃C₂H₅ and —ON═C(C₆H₅)₂ ; and substituted amino radicals selected from alkylamino and arylamino radicals such as —NHCH₃, —NHC₂H₅ and —NH(C₆H₅)₂.

More preferably, the organic silane crosslinking groups are derived from silanes having the general formula RSiY₃, with the most preferred group R being the vinyl radical, and the most preferred Y group being the methoxy and ethoxy radical. Accordingly, the most preferred organic silanes for use in the present invention are vinyltriethoxysilane and vinyltrimethoxysilane.

The amount of silane groups reacted with the non-chlorinated polyolefin depends in part upon the reaction conditions and the degree of modification desired in the polyolefin. The proportion may vary from about 0.1 to about 50% by weight based on the total weight of the silanated resin, more preferably from about 0.5 to 10% by weight, and most preferably from about 1.0 to 5.0% by weight.

The compositions according to the invention can be prepared by a number of different methods. A first preferred method according to the invention involves blending the chlorinated polyolefin, the non-chlorinated polyolefin and the organic silane, together with a free radical initiator, at a temperature sufficient to decompose the initiator and cause grafting of the silane to the polymer components of the composition, in particular to the non-chlorinated polyolefin component. The blending of these components may preferably take place in an extruder at a temperature both above the melt temperature of the polyolefin components and the activation temperature of the free radical initiator. The blend preferably also includes an optional antioxidant processing stabilizer to prevent degradation of the composition in the extruder during the grafting reaction.

The free radical initiator is preferably an organic peroxide selected from the group comprising 1,1-di(tert-butylperoxy)-3,3,5-trimethylcyclohexane, benzoyl peroxide, dichlorobenzoyl peroxide, dicumyl peroxide and di-tertiary butyl peroxide. The criteria for choosing an appropriate free-radical initiator are known to persons skilled in the art and will not be repeated here. These criteria are also described in U.S. Pat. No. 3,646,155 (Scott), issued on Feb. 29, 1972. The Scott patent is incorporated by reference herein in its entirety.

Where the silanation takes place in the presence of the chlorinated polyolefin, it is preferred to use a free radical initiator which has a relatively low activation (decomposition) temperature to avoid dehydrochlorination of the chlorinated polyolefin. Under these conditions, the inventors prefer 1,1-di(tert-butylperoxy)-3,3,5-trimethylcyclohexane which has a relatively low activation temperature of about 275-350° F. (135-177° C.). Where the silanation does not take place in the presence of the chlorinated polyolefin, as discussed below, the preferred free radical initiator is dicumyl peroxide. Preferably, the organic peroxide free-radical initiator is added in an amount of from about 0.1 to about 1.0% by weight of the combined polyolefin components, more preferably from about 0.05 to 0.2% by weight.

During the silanation reaction, the silane will preferentially graft to the non-chlorinated polyolefin component, thereby forming a blend of the chlorinated polyolefin and a silane-grafted polyolefin. The resulting blend may preferably be cooled and pelletized prior to further processing.

The chlorinated polyolefin/silane-grafted polyolefin blend is then further blended with a silanol condensation catalyst and may also be blended with one or more optional ingredients which are identified below. This mixture is then melt processed, for example by extrusion or co-extrusion, thereby shaping it into an article such as a cable jacket or a tube. Where the article is a cable jacket, it will typically be directly extruded over the cable conductors and the jacketed cable is then wound onto spools.

The article is then exposed to moisture, preferably at an elevated temperature, causing the silane groups to form intermolecular crosslinks between the non-chlorinated polyolefin molecules via a combined hydrolysis and condensation reaction. The crosslinks encapsulate the chlorinated polyolefin molecules to form a so-called interpenetrating network. There will also be some direct crosslinking of the non-chlorinated and chlorinated polyolefins in cases where some silane groups have reacted with the chlorinated polyolefin, and where the intermolecular distance between the polyolefin molecules is favourable to allow crosslinking to occur. Atmospheric moisture is usually sufficient to permit the crosslinking to occur, but the rate of crosslinking may be increased by the use of an artificially moistened atmosphere, or by immersion in liquid water. Also, subjecting the composition to combined heat and moisture will accelerate the crosslinking reaction. Preferably, crosslinking is effected at a temperature above about 50° C. and most preferably at a temperature of about 85° C. and a relative humidity of about 90-95% for at least about 24 hours.

Where the article according to the invention comprises a cable jacket, it may not be necessary for the article to be completely moisture crosslinked. Typically, the jacket only needs to be partially crosslinked in order to meet applicable material specifications, such as hot deformation resistance. This test for hot deformation resistance is performed above the melting or softening point of the jacket material. A typical requirement for hot deformation is 30% or less reduction in jacket wall thickness after the application of a 2,000 g weight for 1 hour at 121° C. An example of such a requirement is set out in Underwriters Laboratories Standard UL1277, Electrical Power and Control Cables. In wire and cable manufacture, the jacket is typically crosslinked under ambient conditions, with moisture being supplied by the atmosphere. The crosslinking may occur over a period of several weeks while the spooled cable is awaiting use.

The silanol condensation catalyst is preferably selected from the group comprising organic bases, carboxylic acids and organometallic compounds including organic titanates and complexes or carboxylates of lead, cobalt, iron, nickel, zinc and tin. More preferably, the catalyst is selected from the group comprising dibutyltin dilaurate, dibutyltin diacetate, dibutyltin octanoate, dioctyltin maleate, dibutyltin oxide and titanium compounds such as titanium-2-ethylhexoxide. The most preferred silanol condensation catalyst is dibutyltin dilaurate, though any material which catalyzes the silane condensation reaction is suitable for the invention. The condensation catalyst is preferably added in an amount sufficient that maximum crosslinking will be achieved after a period of 24 hours at a relative humidity of about 95 percent and a temperature of about 85° C. Preferably, the silanol condensation catalyst is added in an amount from about 0.01 to about 10 percent by weight of the composition, more preferably from about 1 to about 5 percent by weight, and most preferably from about 0.05 to about 2 percent by weight. The catalyst may preferably be added in a masterbatch.

In a second preferred method according to the invention, the non-chlorinated polyolefin component may be grafted or copolymerized with the silane to form a silanated polyolefin, this step being performed prior to blending the non-chlorinated polyolefin with the chlorinated polyolefin. In this method, the silanated polyolefin component is subsequently blended with the chlorinated polyolefin and the silanol condensation catalyst in the amounts described above. This blend is then melt processed, for example extruded, to form an article such as a cable jacket and is then crosslinked by exposure to moisture, optionally at an elevated temperature, as described above. Methods for grafting a vinyl silane onto an olefin homopolymer or copolymer, followed by catalyzed hydrolysis and condensation of the silane groups, are described in the above-mentioned Scott patent.

In a third preferred method according to the invention, the silanated polyolefin is purchased as a commercial product. Commercial silanated polyolefins may typically be prepared by copolymerising the silane with the olefin, as opposed to the polyolefin being grafted with the silane. The commercial silanated polyolefin is blended with the chlorinated polyolefin and the silanol condensation catalyst, followed by melt processing and moisture crosslinking as described above.

The thermosetting properties of the composition according to the invention also make them suitable for the manufacture of heat-shrinkable articles, including heat shrinkable tubing as mentioned above. Thermoset articles according to the invention can be rendered heat shrinkable by the following steps: softening the article by heating it above the crystalline melting point of the highest melting polymer component; stretching the softened article beyond its original extruded or moulded dimensions without rupture using relatively low forces; and “freezing” the article in its stretched state by cooling it rapidly to a temperature below the crystalline melting point. The highest melting component may either be the chlorinated polyolefin or the non-chloringated polyolefin, depending on the specific polymers selected. Stretching can be accomplished by mechanical, pneumatic or hydraulic means. After cooling, the stretched crosslinks are held in a stable state by the re-formed, solid crystalline regions. Subsequent re-heating of the stretched article above the crystalline melting point will cause the crystalline regions to re-melt and the structure to revert to its original extruded or moulded dimensions. The crosslinking also prevents the article from becoming liquid during this shrinking process.

The compositions according to the invention may include one or more optional ingredients selected from the group comprising pigmenting agents, mineral fillers, flame-retardant additives, plasticizers, antioxidants, process aids, UV stabilizers, lubricants and compatibilizers.

The optional compatibilizer may be selected from the group comprising: any of the polyethylenes mentioned above; one or more members of the group comprising ethylene-propylene copolymers; ethylene-propylene diene elastomers; crystalline propylene-ethylene elastomers; thermoplastic polyolefin elastomers; metallocene polyolefins; cyclic olefin copolymers; polyoctenamers; copolymers of ethylene with vinyl acetate, vinyl alcohol, and/or alkyl acrylates; polybutenes; hydrogenated and non-hydrogenated polybutadienes; butyl rubber; polyolefins modified with reactive functional groups selected from the group comprising silanes, alcohols, amines, acrylic acids, methacrylic acids, acrylates, methacrylates, glycidyl methacrylates, and anhydrides; polyolefin ionomers; polyolefin nanocomposites; and block copolymers selected from the group comprising styrene-butadiene, styrene-butadiene-styrene, styrene-ethylene/propylene and styrene-ethylene/butylene-styrene.

Where a compatibilising agent is added to the composition of the invention, it is preferably added in an amount from about 1 to about 25 percent by weight.

The antioxidant, also referred to herein as the process stabilizer, may be chosen from any suitable antioxidant or blend of antioxidants designed to prevent degradation of the intermediate resin blends during melt processing. Examples of suitable antioxidant process stabilizers include those classes of chemicals known as hindered phenols, hindered amines, phosphites, bisphenols, benzimidazoles, phenylenediamines, and dihydroquinolines. These may preferably be added in an amount from about 0.1 to 5% by weight of the resin blend, partly depending on the type and quantity of other destabilising ingredients in the composition, such as halogenated flame-retardants or mineral fillers.

Mineral fillers which can be used in the compositions according to the invention include silicates such as talc, clay, mica and wollastonite; calcium carbonate; silica; aluminum and magnesium hydroxide; and metal oxides such as magnesium oxide, alumina and antimony trioxide. These fillers may also be treated with surface coupling agents such as silanes and titanates to promote better bonding of the filler to the polymer matrix.

The flame-retardant additive generally comprises one or more organic halogen compounds wherein the halogen is chlorine or bromine, preferably having a high molecular weight and melting point. Preferred flame-retardant additives may be selected from aromatic and aliphatic compounds such as polybrominated diphenylethers, ethylene bistetrabromophthalimide, tetradecabromodiphenoxybenzene, tetrabromobisphenol A derivatives, hexabromocyclododecane, hexachlorocyclopentadiene, and chlorinated paraffins. A preferred example of a polybrominated diphenylether is decabromodiphenyl oxide.

The organic halogen flame-retardants are preferably used in combination with one or more flame-retardant adjuvants, for example antimony trioxide, which behaves synergistically with the halogen-bearing species, and zinc borate, which acts as both a synergist and smoke suppressor. Since the chlorinated polyolefins already contain halogen, the antimony trioxide synergist may provide sufficient flame-retardancy without the addition of an organic halogen compound.

The flame-retardant additives and adjuvants may preferably be added together as a masterbatch. In one preferred embodiment of the invention, the flame-retardant additive and adjuvant are added as a masterbatch comprising about 30 percent by weight ethylene vinyl acetate copolymer (EVA), about 48 percent by weight decabromobiphenyl oxide, about 16 percent by weight antimony trioxide, along with minor amounts of antioxidants and processing aids.

The invention is further illustrated by the following examples.

### EXAMPLE 1

A chlorinated polyethylene compound (82.84 weight percent) comprising a chlorinated polyethylene resin and additional ingredients as set out in Table 1 was blended with a polyethylene-silane copolymer (12.16 weight percent) and a catalyst masterbatch containing dibutyltin dilaurate silanol condensation catalyst (5.00 weight percent) in a laboratory Brabender mixer at 160° C. The weight ratio of chlorinated polyethylene resin to polyethylene-silane copolymer in this blend was about 3:1.

Plaque samples comprising this mixture were cured in a humidity cabinet at 85° C. and 95% relative humidity. Hot tensile measurements were taken after 24, 48, 120 and 168 hours. The hot tensile test is a tensile test performed above the melting point of the highest melting point resin component of the material, and it measures the strength, and hence extent, of the crosslinked network created during the curing process. It is typically used to measure the progress of the curing reaction. Mechanical properties together with flame-resistance (using Limiting Oxygen Index) and low temperature properties were measured after curing for 168 hours. The hot tensile tests show that about 75% of maximum crosslinking was achieved after 24 hours in the humidity cabinet. The properties of this sample are set out in Tables 2 and 3.

### EXAMPLE 2

The chlorinated polyethylene compound (82.84 weight percent) of Example 1 was blended with silane-grafted EVA (12.16 weight percent) and a catalyst masterbatch containing about 2 weight percent dibutyltin dilaurate silanol condensation catalyst (5.00 weight percent) in a laboratory Brabender at 160° C. The weight ratio of chlorinated polyethylene resin to grafted EVA in this blend was about 3:1.

Plaque samples comprising this mixture were cured in a humidity cabinet at 85° C. and 95% relative humidity. Mechanical properties together with flame-resistance and low temperature properties were measured after curing for 168 hours. The hot tensile tests show that about 90% of maximum crosslinking was achieved after 24 hours in the humidity cabinet. The properties of this sample are set out in Tables 2 and 3.

TABLE 1

| | Example 1 | Example 2 |
|---|---|---|
| Chlorinated | 36.49 | 36.49 |
| Polyethylene | | |
| Resin* | | |
| Clay | 8.76 | 8.76 |
| Mica | 13.14 | 13.14 |
| Silica | 9.24 | 9.24 |
| Crosslink Promoter | 2.35 | 2.35 |
| Antioxidant | 2.15 | 2.15 |
| Magnesium Oxide | 1.95 | 1.95 |
| Antimony Trioxide | 2.92 | 2.92 |
| Process Aid | 0.97 | 0.97 |
| Diundecyl | 4.87 | 4.87 |
| Phthalate | | |
| Silane-Grafted | — | 12.16 |
| EVA** | | |
| PE-Silane | 12.16 | — |
| Copolymer*** | | |
| Catalyst | 5.00 | 5.00 |
| Masterbatch | | |
| Total | 100.00 | 100.00 |

Quantities are expressed in percent by weight.
*Specific Gravity, 1.16 g/cm³; Chlorine Content, 36%; Mooney Viscosity (1 + 4) @ 121° C., 80.
**Specific Gravity, 0.94 g/cm³; Melt Index, 2.7 g/10 min.; Vinylsilane Graft Content, 2%.
***Specific Gravity, 0.92 g/cm³; Melt Index, 0.6 g/10 min.; Vinylsilane Comonomer Content, 4%.

TABLE 2
Hot Tensile Strength @ 140° C. and 40% Elongation

Tensile Strength (psi)

| Time in Chamber | Example 1 | Example 2 |
|---|---|---|
| 24 hr | 12 | 11 |
| 48 hr | 14 | 9 |
| 120 hr | 18 | 12 |
| 168 hr | 16 | 9 |

TABLE 3

| | Example 1 | Example 2 |
|---|---|---|
| Specific Gravity, g/cm³ | 1.36 | 1.32 |
| Tensile Strength, psi | 844 | 660 |
| Elongation, % | 175 | 430 |
| Secant Modulus, psi | 5210 | 3800 |
| Limiting Oxygen Index, % | 28.7 | 27.6 |
| Low Temperature | −10 | −15 |
| Brittleness, ° C. | | |
| Hot Deformation (1 | 3 | 27 |
| hour @ 121° C.), % | | |

### EXAMPLE 3

A commercially available, pre-compounded thermoplastic chlorinated polyethylene compound (94.74 weight percent), was blended with the polyethylene-silane copolymer (5.00 weight percent) of Example 1 and a catalyst masterbatch containing dibutyltin dilaurate silanol condensation catalyst (0.26 weight percent) in a laboratory Brabender mixer at 160° C. The composition of this sample is shown in Table 4.

Plaque samples comprising this mixture were cured in a humidity cabinet at 85° C. and 95% relative humidity. Mechanical properties together with flame-resistance and low temperature properties were measured after curing for 168 hours. The hot tensile tests show that about 400/% of maximum crosslinking was achieved after 24 hours in the humidity cabinet. The properties of this sample are shown in Tables 5 and 6.

TABLE 4

| | Example 3 |
|---|---|
| Chlorinated Polyethylene | 94.74 |
| Compound* | |
| PE-Silane Copolymer | 5.00 |
| Catalyst Masterbatch | 0.26 |
| Total | 100 |

Quantities are expressed in percent by weight.
*Specific Gravity, 1.28 g/cm³;

TABLE 5
Hot Tensile Strength @ 140° C.

| | Tensile Strength | Tensile |
|---|---|---|
| | (psi) | Strength (psi) |
| Time in Chamber | @ 40% Elongation | @ Break |
| 24 hr | 6 | 23 |
| 48 hr | 6 | 25 |
| 120 hr | 10 | 36 |
| 168 hr | 11 | 55 |

TABLE 6

| | |
|---|---|
| Specific Gravity, g/cm³ | 1.25 |
| Tensile Strength, psi | 2730 |
| Elongation, % | 242 |
| Secant Modulus, psi | 26561 |
| Limiting Oxygen Index, % | 28.7 |
| Low Temperature | −30 |
| Brittleness, ° C. | |
| Hot Deformation (1 hour | 2 |
| @ 121° C.), % | |

### EXAMPLE 4

The chlorinated polyethylene resin of Example 1 (54.78 weight percent) was blended with the silane-grafted EVA of Example 2 (29.70 weight percent), a catalyst masterbatch containing dibutyltin dilaurate silanol condensation catalyst (4.38 weight percent), antioxidant (1.22 weight percent) and an antimony trioxide masterbatch (9.92 weight percent) in a laboratory Brabender mixer at 160° C. The composition of this sample is shown in Table 7.

Plaque samples comprising this mixture were cured in a humidity cabinet at 85° C. and 95% relative humidity. Hot tensile measurements were taken after 24, 48, 120 and 168 hours. Mechanical properties together with flame-resistance and low temperature properties were measured after curing for 168 hours. The hot tensile tests show that crosslinking was achieved, with maximum cure occurring after about 24 hours in the relative humidity cabinet. The properties of this sample are shown in Tables 8 and 9.

### EXAMPLE 5

The chlorinated polyethylene resin of Example 1 (54.78 weight percent) was blended with the polyethylene-silane copolymer of Example 1 (29.70 weight percent), a catalyst masterbatch containing dibutyltin dilaurate silanol condensation catalyst (4.38 weight percent), antioxidant (1.22 weight percent) and an antimony trioxide masterbatch (9.92 weight percent) in a laboratory Brabender mixer at 160° C. The composition of this sample is shown in Table 7.

Plaque samples comprising this mixture were cured in a humidity cabinet at 85° C. and 95% relative humidity. Hot tensile measurements were taken after 24, 48, 120 and 168 hours. Mechanical properties together with flame-resistance and low temperature properties were measured after curing for 168 hours. The hot tensile tests show that crosslinking was achieved, with maximum cure occurring after about 24 hours in the relative humidity cabinet. The polyethylene-silane copolymer provides a greater degree of curing but at the expense of flexibility compared with the EVA-based graft. The properties of this sample are shown in Tables 8 and 9.

TABLE 7

| | Example 4 | Example 5 |
|---|---|---|
| Chlorinated Polyethylene | 54.78 | 54.78 |
| Resin | | |
| Silane Grafted EVA | 29.70 | — |
| PE-Silane Copolymer | — | 29.70 |
| Catalyst Materbatch | 4.38 | 4.38 |
| Antioxidant | 1.22 | 1.22 |
| Antimony Trioxide | 9.92 | 9.92 |
| Total | 100.00 | 100.00 |

Quantities are expressed in percent by weight.

TABLE 8
Hot Tensile Strength @ 140° C.

Tensile Strength @ Break (psi)

| Time in Chamber | Example 4 | Example 5 |
|---|---|---|
| 24 hr | 41 | 70 |
| 48 hr | 38 | 80 |
| 120 hr | 37 | 70 |
| 168 hr | 33 | 71 |

TABLE 9

| | Example 4 | Example 5 |
|---|---|---|
| Specific Gravity, g/cm³ | 1.19 | 1.17 |
| Tensile Strength, psi | 931 | 846 |
| Elongation, % | 663 | 181 |
| Secant Modulus, psi | 1895 | 4846 |
| Limiting Oxygen Index, % | 27.6 | 27 |
| Low Temperature | −45 | −20 |
| Brittleness, ° C. | | |
| Hot Deformation (1 hour | 27 | 8 |
| @ 121° C.), % | | |

### EXAMPLE 6

The chlorinated polyethylene resin of Example 1 (75 parts by weight), a linear low density polyethylene resin (25 parts by weight), and a processing aid (5 parts by weight) were mixed in a high speed mixer with the slow addition of a grafting solution comprised of vinyltriethoxysilane, a free radical initiator comprising 1,1-di(tert-butylperoxy)-3,3,5-trimethylcyclohexane, and antioxidant. The grafting solution accounted for 5.7 weight percent of the total mixture and the silane, peroxide and antioxidant contents of the total mixture were about 0.2, 0.08 and 0.5 weight percent, respectively. The total mixing time was 2 minutes. The mixture was then grafted on a single screw extruder at a melt temperature of 300-365° F. (149-185° C.). The composition of the grafted resin mixture is shown in Table 10.

After grafting, the grafted resin mixture was mixed in a laboratory Brabender mixer at 160° C. with a catalyst masterbatch. The composition of this sample (designated composition “G2”) is shown in Table 11.

Plaque samples comprising this mixture were cured in a humidity cabinet at 85° C. and 95% relative humidity. Hot tensile measurements were taken after 24, 48, 120 and 168 hours. Mechanical properties together with flame-resistance and low temperature properties were measured after curing for 168 hours. The hot tensile tests show that crosslinking was achieved, with maximum cure occurring after about 48 hours in the humidity cabinet. The addition of the flame-retardant masterbatch raised the low temperature brittle point from −40° C. to −25° C., but the oxygen index improved from 21% to 26.5%. The properties of this sample are shown in Tables 12 and 13.

### EXAMPLE 7

The chlorinated polyethylene resin of Example 1 (75 parts by weight), the linear low density polyethylene resin of Example 6 (25 parts by weight) and a processing aid (5 parts by weight) were mixed in a high speed mixer with the slow addition of a grafting solution comprised of vinyltriethoxysilane, a free radical initiator comprising 1,1-di(tert-butylperoxy)-3,3,5-trimethylcyclohexane, and antioxidant . The grafting solution accounted for 5.7 weight percent of the total mixture and the silane, peroxide and antioxidant contents of the total mixture were about 0.2, 0.08 and 0.5 weight percent, respectively. The total mixing time was 2 minutes. The mixture was then grafted on a single screw extruder at a melt temperature of 300-365° F. (149-185° C.). The composition of the grafted resin mixture is shown in Table 10.

After grafting, the grafted resin mixture was mixed in a laboratory Brabender mixer at 160° C. with a catalyst masterbatch and a flame-retardant masterbatch. The catalyst masterbatch contained dibutyltin dilaurate silanol condensation catalyst and the flame-retardant masterbatch contained 30.1% EVA, 48.8% decabromobiphenyl oxide, 16.3% antimony trioxide, 3.61% antioxidant stabilizer and 1.19% polyethylene wax as a processing aid. The composition of this sample is shown in Table 11.

Plaque samples comprising this mixture were cured in a humidity cabinet at 85° C. and 95% relative humidity. Hot tensile measurements were taken after 24, 48, 120 and 168 hours. Mechanical properties together with flame-resistance and low temperature properties were measured after curing for 168 hours. The hot tensile tests show that crosslinking was achieved, with maximum cure occurring after about 48 hours in the humidity cabinet. The addition of the flame-retardant masterbatch raised the low temperature brittle point from −40° C. to −25° C., but the oxygen index improved from 21% to 26.5% compared with Example 6. The lower hot deformation resistance is primarily due to the low softening point EVA binder used in the flame-retardant masterbatch. The properties of this sample are shown in Tables 12 and 13.

### EXAMPLE 8

For the purpose of comparison, the chlorinated polyethylene resin of Example 1 (100 parts by weight) and a processing aid (5 parts by weight) were mixed in a high speed mixer with the slow addition of the grafting solution of Examples 6 and 7. The total mixing time was 2 minutes. The mixture was then grafted on a single screw extruder at a melt temperature of 300-365° F. (149-185° C.).

TABLE 10
Grafted Resin Formulations

| | Example 6 | Example 7 | Example 8 |
|---|---|---|---|
| Chlorinated Polyethylene Resin | 75 | 75 | 100 |
| Linear Low Density | 25 | 25 | — |
| Polyethylene* | | | |
| Process Aid | 5 | 5 | 5 |
| Total | 105 | 105 | 105 |

Quantities are expressed in parts by weight.
*Specific Gravity, 0.92 g/cm³; Melt Index, 6.0 g/10 min.

TABLE 11

| | Example 6 | Example 7 | Example 8 |
|---|---|---|---|
| Grafted Resin (Table 10) | 95 | 95 | 95 |
| Flame Retardent Masterbatch | | 25 | |
| Catalyst Masterbatch | 5 | 5 | 5 |
| Total | 100 | 125 | 100 |

Quantities are expressed in parts by weight.

TABLE 12
Hot Tensile Strength @ 140° C.

| | Tensile Strength @ Break (psi) | | |
|---|---|---|---|
| Time in Chamber | Example 6 | Example 7 | Example 8 |
| 24 hr | 63 | 55 | 60 |
| 48 hr | 79 | 70 | — |
| 120 hr | 81 | 72 | 69 |
| 168 hr | 76 | 68 | 70 |

TABLE 13

| | Example 6 | Example 7 | Example 8 |
|---|---|---|---|
| Specific Gravity, g/cm³ | 1.09 | 1.19 | 1.15 |
| Tensile Strength, psi | 1284 | 1392 | 1199 |
| Elongation, % | 591 | 576 | 749 |
| Secant Modulus, psi | 4076 | 3953 | 849 |
| Limiting Oxygen Index, % | 21 | 26.5 | 22.6 |
| Low Temperature | −40 | −25 | −60 |
| Brittleness, ° C. | | | |
| Hot Deformation (1 hour | 9 | 30 | 53 |
| @ 121° C.), % | | | |

By comparing the data for Examples 6 and 8, it can be concluded that silanating a blend of a chlorinated polyolefin resin and a non-chlorinated polyethylene provides an article having better hot deformation properties than that produced by silanating the chlorinated polyolefin resin alone. The hot deformation data for Example 8 does not meet the industry standards mentioned above, which require deformation of 30% or less. It is believed that the improvement in hot deformation resistance provided by the compositions of the present invention is at least partly due to an increased level of grafting between the silane and the non-chlorinated polyethylene, which results in a denser crosslinked network.

Although the invention has been described in relation to certain preferred embodiments, it will be appreciated that it is not intended to be limited thereto. Rather, the invention is intended to encompass all embodiments which fall within the scope of the following claims.

What is claimed is:

1. A moisture-crosslinked, flame-retardant article formed from a thermosetting, moisture-crosslinkable polymer composition, the polymer composition comprising a blend of:
(a) a chlorinated polyolefin;
(b) a non-chlorinated polyethylene selected from the group consisting of polyethylene homopolymers and copolymers;
(c) hydrolysable silane groups bonded to molecules of the non-chlorinated polyethylene; and
(d) a silanol condensation catalyst;
wherein the weight ratio of the chlorinated polyolefin to the non-chlorinated polyethylene is at least about 1:1;
wherein the hydrolysable silane groups form silane crosslinks between the polyethylene molecules upon exposure to moisture, and wherein the degree of crosslinking is sufficient to provide the article with thermoset properties.

2. The moisture-crosslinked, flame-retardant article of claim 1, wherein the weight ratio of the chlorinated polyolefin to the non-chlorinated polyethylene is at least about 1.5:1.

3. The moisture-crosslinked, flame-retardant article of claim 1, wherein the weight ratio of the chlorinated polyolefin to the non-chlorinated polyethylene is about 3:1.

4. The moisture-crosslinked, flame-retardant article of claim 1, wherein the non-chlorinated polyethylene is added to the composition in an amount of from about 10 to about 30 percent by weight.

5. The moisture-crosslinked, flame-retardant article of claim 1, wherein the silanol condensation catalyst is added to the composition in an amount of from about 0.01 to about 10 percent by weight of the composition.

6. The moisture-crosslinked, flame-retardant article of claim 5, wherein the amount of the silanol condensation catalyst is from about 0.05 to about 2 percent by weight of the composition.

7. The moisture-crosslinked, flame-retardant article of claim 1, wherein the chlorinated polyolefin is selected from the group consisting of polychloroprene, chlorosulfonated polyethylene, poly(vinyl chloride) and chlorinated polyethylene.

8. The moisture-crosslinked, flame-retardant article of claim 1, wherein the chlorinated polyolefin is selected from the group consisting of chlorinated polyethylene and chlorosulfonated polyethylene.

9. The moisture-crosslinked, flame-retardant article of claim 1, wherein the non-chlorinated polyethylene homopolymer is selected from the group consisting of low density polyethylene, high density polyethylene and linear low density polyethylene.

10. The moisture-crosslinked, flame-retardant article of claim 1, wherein the non-chlorinated polyethylene copolymer comprises a copolymer of ethylene with one or more olefins other than ethylene having from 3 to 20 carbon atoms.

11. The moisture-crosslinked, flame-retardant article of claim 10, wherein the olefin other than ethylene is selected from one or more members of the group consisting of propylene, butene, hexene, octene, ethylidene norbornene, vinyl acetate, methyl acrylate, ethyl acrylate and butyl acrylate, or wherein the copolymer of ethylene is selected from the group consisting of ethylene-propylene elastomers and ethylene-propylene-diene elastomers.

12. The moisture-crosslinked, flame-retardant article of claim 1, wherein the silanol condensation catalyst is selected from one or more members of the group consisting of dibutyltin dilaurate, dibutyltin diacetate, dibutyltin octanoate, dioctyltin maleate, dibutyltin oxide and titanium-2-ethylhexoxide.

13. The moisture-crosslinked, flame-retardant article of claim 1, wherein each of the hydrolysable silane groups comprises from one to three hydrolysable organic radicals bonded to a silicon atom, wherein each of the hydrolysable organic radicals is selected from the group consisting of: methoxy, ethoxy and butoxy radicals; formyloxy, acetoxy and propionoxy radicals; —ON═C(CH₃)₂, —ON═CCH₃C₂H₅ and —ON═C(C₆H₅)₂ radicals; and —NHCH₃, —NHC₂H₅ and —NH(C₆H₅)₂ radicals.

14. The moisture-crosslinked, flame-retardant article of claim 1, wherein the composition further comprises one or more ingredients selected from the group consisting of pigmenting agents, mineral fillers, flame-retardant additives, plasticizers, antioxidants, process aids, UV stabilizers, lubricants and compatibilizers.

15. The moisture-crosslinked, flame-retardant article of claim 14, wherein the flame-retardant additives are selected from one or more members of the group consisting of polybrominated diphenylethers, ethylene bistetrabromophthalimide, tetradecabromodiphenoxybenzene, tetrabromobisphenol A derivatives, hexabromocyclododecane, hexachlorocyclopentadiene, and chlorinated paraffins.

16. The moisture-crosslinked, flame-retardant article of claim 15, wherein the flame-retardant additive further comprises one or more flame-retardant adjuvants selected from the group consisting of antimony trioxide and zinc borate.

17. The moisture-crosslinked, flame-retardant article of claim 14, wherein the compatibilizer is selected from one or more members of the group consisting of polyethylene homopolymers; copolymers of ethylene with one or more olefins other than ethylene having from 3 to 20 carbon atoms, including copolymers of ethylene with propylene, vinyl acetate, vinyl alcohols, and alkyl acrylates; ethylene-propylene diene elastomers; crystalline propylene-ethylene elastomers; thermoplastic polyolefin elastomers; metallocene polyolefins; cyclic olefin copolymers; polyoctenamers; polybutenes; hydrogenated and non-hydrogenated polybutadienes; butyl rubber; polyolefins modified with reactive functional groups selected from the group consisting of silanes, alcohols, amines, acrylic acids, methacrylic acids, acrylates, methacrylates, glycidyl methacrylates, and anhydrides; polyolefin ionomers; polyolefin nanocomposites; and block copolymers selected from the group consisting of styrene-butadiene, styrene-butadiene-styrene, styrene-ethylene/propylene and styrene-ethylene/butylene-styrene.

18. The moisture-crosslinked, flame-retardant article of claim 1, wherein the article comprises a jacket for electrical cable, or heat-shrinkable tubing.

19. A method for manufacturing a moisture-crosslinked, flame-retardant article, comprising:
(a) providing a non-chlorinated, ethylene-based polymer containing hydrolysable silane groups, wherein the ethylene-based polymer comprises ethylene copolymerized with an organic silane, polyethylene homopolymer grafted with an organic silane, or a polyethylene copolymer grafted with an organic silane;
(b) blending the ethylene-based polymer with a chlorinated polyolefin and a silanol condensation catalyst to form a moisture-crosslinkable, thermosetting composition, wherein the weight ratio of the chlorinated polyolefin to the ethylene-based polymer is at least about 1: 1;
(c) melt processing the composition to form the article;
(d) exposing the article to moisture so as to hydrolyse at least some of the silane groups of the ethylene-based polymer and thereby form silane crosslinks between molecules of the ethylene-based polymer, wherein the degree of crosslinking is sufficient to impart thermoset properties to the article.

20. The method of claim 19, wherein the non-chlorinated, ethylene-based polymer is formed by grafting the organic silane with the polyethylene homopolymer or copolymer.

21. The method of claim 19, wherein the non-chlorinated, ethylene-based polymer is formed by grafting the organic silane with a copolymer of ethylene with one or more olefins other than ethylene having from 3 to 20 carbon atoms.

22. The method of claim 19, wherein the non-chlorinated, ethylene-based polymer is formed by copolymerizing the organic silane with polyethylene.

23. The method of claim 19, wherein the melt processing comprises extrusion and wherein the article comprises electrical cable or tubing.

24. The method of claim 19, wherein the moisture to which the article is exposed comprises ambient atmospheric moisture.

25. A method for manufacturing a moisture-crosslinked, flame-retardant article, comprising:
(a) blending together a chlorinated polyolefin, a non-chlorinated polyethylene selected from the group consisting of polyethylene homopolymers and copolymers, and an organic silane;
(b) forming a grafted polymer mixture by reacting the organic silane with the non-chlorinated polyethylene, thereby grafting the organic silane to the non-chlorinated polyethylene in the form of hydrolysable silane groups;
(c) forming a moisture-crosslinkable, thermosetting composition by blending the grafted polymer mixture with a silanol condensation catalyst;
(d) melt processing the composition to form the article;
(e) exposing the article to moisture so as to hydrolyse at least some of the silane groups and thereby form silane crosslinks between molecules of the non-chlorinated polyethylene, wherein the degree of crosslinking is sufficient to impart thermoset properties to the article.

26. The method of claim 25, wherein the organic silane has the general formula RR′SiY₂, wherein R represents a monovalent olefinically unsaturated hydrocarbon or hydrocarbonoxy radical, Y represents a hydrolysable organic radical and R′ represents a monovalent olefinically unsaturated hydrocarbon or hydrocarbonoxy radical, or a hydrolysable organic radical.

27. The method of claim 26, wherein the monovalent olefinically unsaturated hydrocarbon or hydrocarbonoxy radical is selected from the group comprising vinyl, allyl, butenyl, cyclohexenyl, cyclopentadienyl, and cyclohexadienyl.

28. The method of claim 26, wherein Y represents a hydrolysable organic radical selected from the group comprising methoxy, ethoxy, butoxy, formyloxy, acetoxy, propionoxy; oximo radicals selected from the group comprising —ON═C(CH₃)₂, —ON═CCH₃C₂H₅ and —ON═C(C₆H₅)₂ ; and substituted amino radicals selected from the group comprising alkylamino and arylamino radicals.

29. The method of claim 26, wherein the silane has general formula RSiY₃, wherein R is vinyl and Y is methoxy or ethoxy.

30. The method of claim 25, wherein the amount of the silane is from about 1.0 to about 5.0 percent by weight of the grafted polymer mixture.

31. The method of claim 26, wherein the article comprises heat-shrinkable tubing and wherein the method further comprises:
(f) softening the article crosslinked in step (e) by application of heat thereto, stretching the heated article and then freezing the article in its stretched form by rapid cooling.

32. The method of claim 26, wherein the reaction of the organic silane with the non-chlorinated polyethylene is initiated by a peroxide free-radical initiator.

33. The method of claim 32, wherein the peroxide free-radical initiator comprises 1,1-di(tert-butylperoxy)-3,3,5-trimethylcyclohexane.
